(19) United States
(12) Patent Application Publication
(10) Pub. No.: US 2018/0254001 A1
(43) Pub. Date: Sep. 6, 2018

(54) AUGMENTED REALITY ADVERTISING SYSTEM WITH SMART PHONE INTEROPERABILITY

(71) Applicant: Doron Koren, Kfar Sirkin (IL)

(72) Inventor: Doron Koren, Kfar Sirkin (IL)

(21) Appl. No.: 15/909,945

(22) Filed: Mar. 1, 2018

Related U.S. Application Data
(60) Provisional application No. 62/465,279, filed on Mar. 1, 2017.

(51) Int. Cl. G09G 3/00; G06T 19/00; G02B 27/01; G06Q 30/02; G06Q 50/00

(52) U.S. Cl. CPC G09G 3/001; G06T 19/006; G02B 27/0101; H04M 1/0202; G06Q 30/0261; G06Q 50/01; G02B 27/0149

(57) ABSTRACT

An augmented reality projection system includes a projector aimed at a reflective coating, a processor operably coupled to the projector and a virtual image bank accessible from the processor. A motorized gimbal positioning system aims the projector for various effects. A camera determines image locations and distortion. GPS and IMU devices supply location and motion information for determining location and heading relevant images. Communications with a smart phone enable user interaction and input. Thus a relevant interactive augmented reality display is created for the benefit of a passenger.

### RELATED APPLICATION

This application is a nonprovisional of and claims the benefit of priority of U.S. Provisional Application 62/465,279 filed 1 Mar. 2017, the entire contents of which are incorporated herein by this reference and made a part hereof.

### FIELD OF THE INVENTION

This invention relates to displays projected onto passenger windows of vehicles, and, more particularly, to interactive displays projected on passenger windows of public transportation vehicles.

### BACKGROUND

Conventional head-up displays (HUDs) in cars today are used for displaying information relating to vehicle control, navigation and safety. Such HUDs do not project images that are compensated by a vehicle's movement. Thus, projected images do not appear stationary relative to the landscape view. Concomitantly, conventional HUDs do not pre-distort a projected image to compensate for a windows curvature, such as the curvature of a side window of a vehicle. Additionally, conventional HUDs do not provide means for user interaction.

A system and method for displaying images on passenger windows of a vehicle is needed. The projected images should change with and correspond to the real images viewable through the window. The projected image should be transformed to avoid distortion from window curvature. The projected image should also enable user interaction.

The invention is directed to overcoming one or more of the problems and solving one or more of the needs as set forth above.

### SUMMARY OF THE INVENTION

To solve one or more of the problems set forth above, in an exemplary implementation of the invention, an augmented reality projection system is provided. The system includes a reflective coating on a passenger window of a moving vehicle, a projector aimed at the reflective coating, an image processor (e.g., a portable computing device such as a tablet) operably coupled to the projector and a virtual image bank accessible from the image processor. The image processor selects an image (e.g., an image file) from the image bank and causes the projector to project the image on the reflective coating on the window. Thus an augmented reality display is created for the benefit of a passenger.

The system includes location and motion detection capabilities to determine images of local relevance. A global positioning system (GPS) and an inertial measurement unit (IMU) are operably coupled to the image processor. The GPS is a radionavigation receiver that receives geolocation and time information from a plurality of GPS satellites. The IMU detects linear acceleration using one or more accelerometers, rotational rate using one or more gyroscopes and heading using a magnetometer (e.g., an accelerometer, a gyro, and a magnetometer per axis for each of three orthogonal axes). The image processor determines a location, speed and heading using the GPS and IMU information. The image selected from the image bank may therefore be an image associated with the determined location.

A digital camera (e.g., a camera with CCD or CMOS image sensors, memory for storage of image data, and an interface for coupling to the image processor) aimed at the passenger window facilitates calibration and detection. Calibration or pre-distortion entails determining pixel location adjustments to negate distortion caused by window curvature, which may vary from vehicle to vehicle. Detection entails determining the location of images on the window. Detection may be used to display a projected image on or adjacent to a real image. Detection may also be used to move an image across a window consistent with movement of real images moving relative to the window.

A positioning system may be provided to physically aim the projector. The positioning system may include a gimbal assembly (e.g., an inner gimbal and an outer gimbal with a universal joint coupling) providing two axes of freedom, a pair of motors operably coupled to the gimbal system to cause rotations about the two axes of freedom (e.g., one motor for the inner gimbal and another for the outer gimbal), a mounting base and a platform. The gimbal assembly is pivotally coupled between the mounting base and platform. The projector is mounted to the platform. A motor controller controls each motor. The motor controller is operably coupled to the image processor. The image processor may cause the positioning system to aim the projector at a first determined portion of the reflective coating on the passenger window at a first time, and cause the positioning system to aim the projector at a second determined portion of the reflective coating on the passenger window at a second time, and cause the positioning system to aim the projector at a continuum of portions of (i.e., move along) the reflective coating on the passenger window over a first period of time.

The image processor may communicate with a portable computing device (e.g., a passenger's smart phone). Such communication may be peer to peer or via a network such as the Internet. In one implementation, communications are routed through a server accessible on the Internet. The image processor communicates first information related to the image projected on the reflective coating on the window to the portable computing device. The portable computing device communicates second information, such as to the image processor and/or to a remote computing system. The second information may indicate a user input (e.g., a click through, an email address, a phone number, or a subjective assessment such as a like). The remote computing system may host a social network, such as Facebook. The remote computing system may publish such information, such as in the case of a “like.”

### BRIEF DESCRIPTION OF THE DRAWINGS

The foregoing and other aspects, objects, features and advantages of the invention will become better understood with reference to the following description, appended claims, and accompanying drawings, where:

FIG. 1 conceptually illustrates a first embodiment of a projection system according to principles of the invention; and

FIG. 2 conceptually illustrates a second embodiment of a projection system according to principles of the invention; and

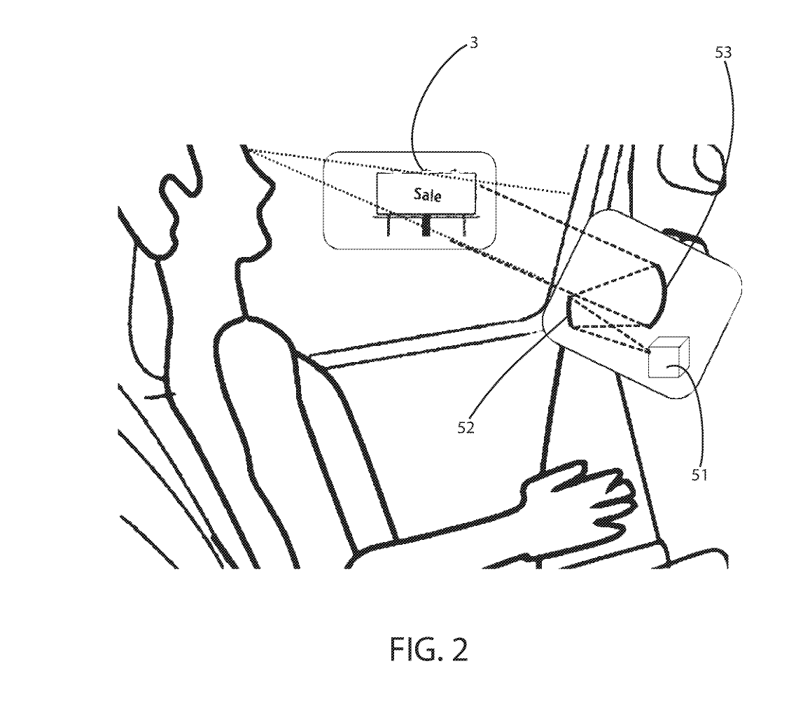

FIG. 3 conceptually illustrates a third embodiment of a projection system according to principles of the invention; and

FIG. 4 conceptually illustrates a fourth embodiment of a display system according to principles of the invention; and

FIG. 5 conceptually illustrates a projected image location and movement methodology for a display system according to principles of the invention; and

FIG. 6 conceptually illustrates components of a projection system according to principles of the invention; and

FIG. 7 is a flowchart for a method of selecting and displaying an image relevant to a real world object visible through the window using a projection system according to principles of the invention; and

FIG. 8 conceptually illustrates a fifth embodiment of a projection system according to principles of the invention; and

FIG. 9 conceptually illustrates a two-axis motorized gimbal for aiming a projector of a projection system according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

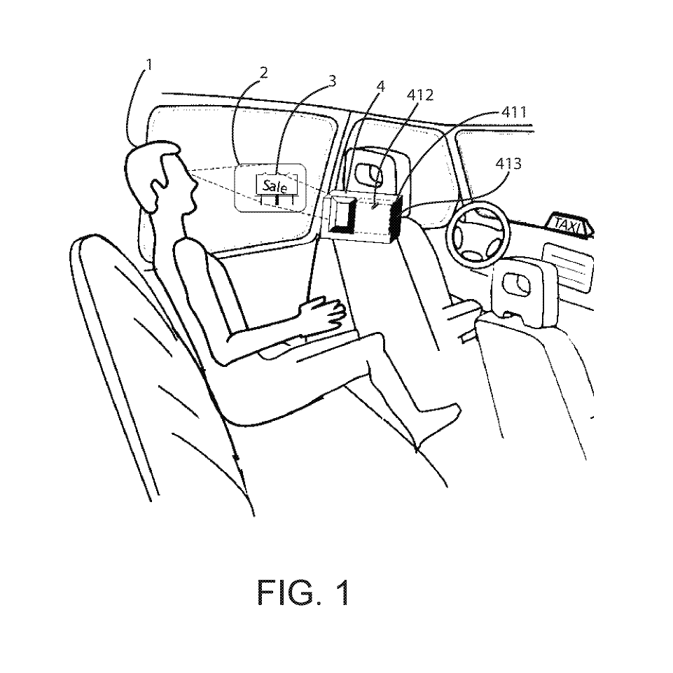

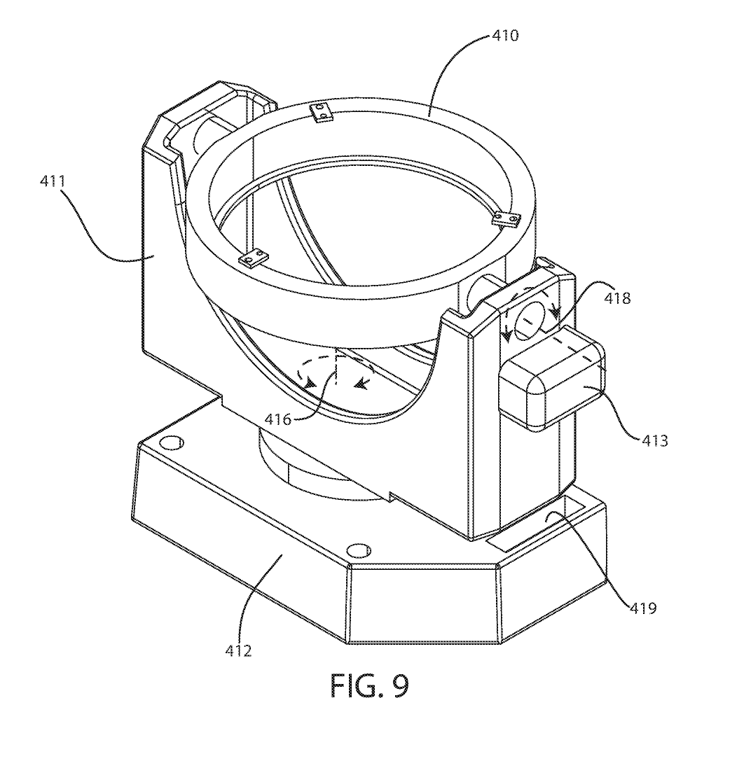

Referring to FIG. 1, an exemplary head-up display projector 4 is mounted to a surface in the vicinity of a targeted window. Such a surface may include a back of a headrest, back of a seat or a mounting platform on the back of a center console. The projector 4 is aimed at the window. In a preferred embodiment, the mounting includes a gimbal assembly 411 with at least two axes of freedom. In a particular preferred embodiment, the gimbal system, a nonlimiting example of which is shown in FIG. 9, is driven by motors such as servo motors to control aiming of the projector 4.

In one exemplary implementation, the window is coated with one or more optical layers, forming an optical laminate 2 that enhances reflection without preventing transmission. The layer(s) is (are) applied to the interior side of the window. The optical laminate may include a photochromatic (i.e., photochromic) layer to attenuate ambient sunlight during the day and keep the window transparent and clear during the night time. Attenuation refers to a reduction of sunlight (i.e., radiation from the sun) transmitted through a window. The photochromic layer includes a photochromic coating that reacts (i.e., darkens) upon exposure to specific types of light of sufficient intensity, most commonly ultraviolet (UV) radiation. The photochromic layer may be comprised of inorganic or organic photochromes, such as, but not limited to, silver chloride, spiropyrans, spirooxazines, diarylethenes, azobenzenes, or photochromic quinones. Optionally, an electrochromic layer may be provided in lieu of a photochromic layer. The electrochromic layer facilitates light control. The electrochromic layer may comprise an electrochrome such as tungsten trioxide, tungstic anhydride or other transition metal oxides, which reversibly change color when undergoing electrochemical redox reactions precipitated by bursts of charge. The optical laminate may also include a semi-reflective film comprised of a substrate coated with a reflective material (e.g., a metalized film). In one embodiment the substrate is polyethylene terephthalate (PET) and the coating is a thin (almost transparent) layer of aluminum. In another embodiment, the metalization is deposited on the inward facing side of the photochromic layer. The result is a mirrored surface that reflects some light and is penetrated by the rest. Light passes equally in both directions. However, when one side is brightly illuminated by a projector and the other side is darker, the darker side (i.e., the side outside of the window) becomes difficult to see from the reflection on the brightly illuminated side, because the darker side is obscured by the much brighter reflection of the illuminated side. Thus, the semi-reflective film reflects the image projected onto the window. The optical laminate may also include a micro-lens array layer. The array reflects, via total internal reflection, some of the light arriving from the projector. Total internal reflection occurs when a propagated wave strikes a medium boundary at an angle larger than a particular critical angle with respect to the normal to the surface. If the refractive index is lower on the other side of the boundary and the incident angle is greater than the critical angle, the wave cannot pass through and is entirely reflected. Other light from the projector that passes through the lens is reflected by the semi-reflective film and then focused by the lenses.

A micro-lens array layer is substantially transparent, allowing a viewer to clearly see exterior objects together with projected image. In one embodiment, the layer is comprised of an array of concave lenses etched into a substrate (e.g., a polymer substrate), e.g., by laser etching or a lithographic process. In another embodiment, convex lens dots (e.g., spherical, hemispherical, or bulbous deposits), are formed on a substrate (e.g., a polymer substrate), such as by 3D printing or a lithographic process.

The projector 4 is an image projector, i.e., an optical device that projects an image (or moving images) onto a surface, in this case the targeted window. The projector creates the image by shining one or more lights (e.g., LEDs) through a transparent lens. Such projectors are known in the art and commercially available. A nonlimiting example is a DLP, LED or LCD projector with wireless network connectivity and running on the Android operating system.

A function of the gimbal assembly 411 is to aim the projector 4 at the targeted window. Another function of the gimbal assembly 411 is to stabilize the image 3, to counteract drifting and vibrations due to the vehicle's suspension and road. One or more optical sensors (e.g., a charged coupled device CCD) aimed at the window may detect changes in projected image position, from which a corrective counteracting motion may be determined and communicated to the controller of the gimbal assembly for corrective rotations of the motors. Another function of the gimbal assembly 411 is to impart motion to the projected image, i.e., move the projected image along the targeted window. Such movement creates the appearance of a stationary object traversing the outside landscape. The physical image movement allows the total projection energy to be focused and used within the displayed image, without sacrificing the entire projection energy on portions of the window that are not in use. This allows use of a small compact projector. In addition, fine movement compensation may be achieved by digitally moving the image without or in addition to the physical gimbal operation to perform virtual electronic stabilization.

Referring to FIG. 9, a nonlimiting example of a two-axis gimbal system includes a base 412, which may house a motor to rotate a pair of gimbals 410, 411, about a first axis 416. Another motor 413 is attached to an outer gimbal 411 to rotate the payload platform 410 about axis 418. The base 412 may be attached (e.g., with a mounting strap through apertures 419, or mechanical fasteners through mounting holes, or welding, clamping or bonding) to a mounting structure, such as a headrest, seat back, center console or some other structure from which a clear line of site is provided to a targeted window. Axis 418 is orthogonal to axis 416. The motors may be servo or stepper motors, actuated with a motor controller and driver to cause determined rotations. The rate, direction and range of rotation are all controlled by the controller and driver. The projector is mounted to the payload platform 410.

In addition fine movement compensation can be achieved by digitally moving the image, without or in addition to a physical gimbal operation, to perform virtual electronic stabilization. Thus, the projector may move the image, without departing from the scope of the invention. Minimal movements will not appreciably compromise efficiency of the display.

A motor controller may be housed in the base 412. In the case of servo motors, the controller is a servo controller with precise closed loop position control and precise speed control. Such a servo controller may use position feedback to close the control loop. Position feedback may be implemented with encoders, resolvers, and/or Hall effect sensors to directly measure the rotor's position. An alternative position feedback method measures back EMF in undriven coils to infer the rotor position, or detects kick-back voltage transient (spike) that is generated whenever the power to a coil is instantaneously switched off. Each servo may be controlled using pulse-width modulation (PWM). How long the pulse remains high (typically between 1 and 2 milliseconds) determines where the motor will try to position itself. Another control method is pulse and direction.

Alternatively, in the case of a stepper motor, the motor controller emits a pulse signal for each motor, with the amount of rotation being proportional to the number of pulses, the rate of rotation being proportional to the pulse frequency, and the direction of rotation being determined by a direction signal. The stepper motor controller is coupled to a driver which energizes the stepper motors in response to the controller output. A driver may be provided for each stepper motor.

As the passenger 1 looks through the window, he or she sees a projected virtual image 3 overlayed on the real landscape. This image can be advertising, promotional or any other information, for commercial, entertainment, or any other purpose. The image may be stationary or moving. The image may be overlayed on a real image visible through the window, and movable as the real image moves across the window.

A calibration image may be projected and analyzed using a CCD to correct (i.e., predistort aka inverse distortion) for subsequent image display. A predistorted image displayed on a curved window, will look like the original image displayed on a flat screen. Distortion from window curvature is negated by inverse distortion. Inverse distortion is determined pixel-by-pixel, by comparing projected pixel location with original image pixel location. Predistortion negates the distortion of a pixel that is attributed to window curvature. The predistortion process entails dividing an image into regions. The CCD captures each pixel in each region. For each pixel the system (i.e., a programmed computer such as a tablet) calculates a correlation function. The correlation function represents the similarity between the original image pixel and the displayed pixel. Once the correlation function values for all the pixels are calculated and stored in a matrix, the system finds the maximum value of the correlation function. The system stores the correction as a shift in number of pixels of the corresponding pixel with the maximum value. Such process is repeated for all the regions of the image.

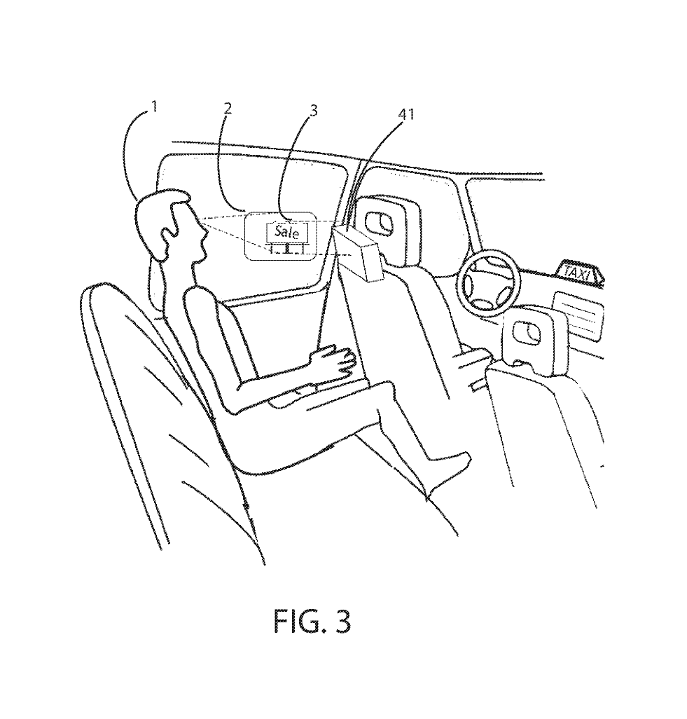

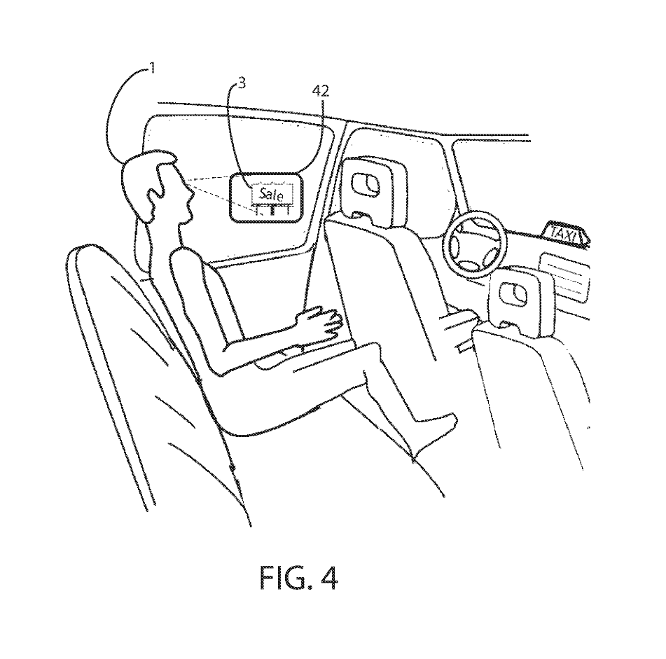

Referring to FIG. 3, the HUD may be replaced by or supplemented with a conventional display screen 41 such as an LCD or OLED screen. Such a display screen may display the same image as displayed in the window, information pertaining to the image displayed on the window, or unrelated information. In FIG. 4, an OLED screen 42 is provided on the window. The OLED screen 42 may display images in addition to or in lieu of the projected images. The OLED 42 may be substantially transparent.

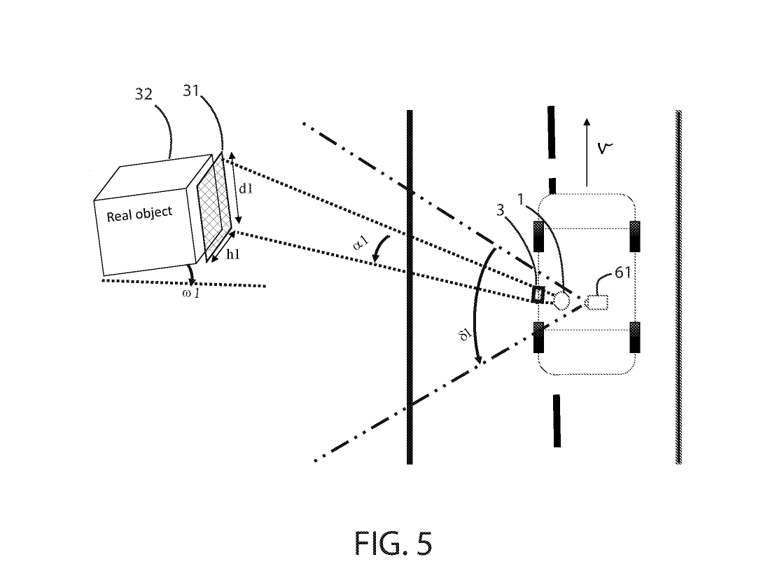

Referring to FIG. 5, the vehicle orientation, acceleration and velocity changes in time as sensed by the GPS and Inertial Measurement Unit (IMU) system. Camera 61 captures in real time the landscape and provides the information to the system for further image processing. The purpose of image processing is to lock the augmented (projected) object 31 on the real object 32. The system calculates the size and 3D distortion of image 31 to be projected as image on the window 3 in order to fit the image on the real object dimensions. This is done by compensating for vehicle speed, direction and distance from the real object 32. Object 32 either can be real or imaginary.

The image processing block 66 can be implemented by widely used and known image processing algorithms in computer gaming, such as edge detection, Primal sketch, Marr, Mohan and Nevatia, Lowe, Olivier Faugeras, changes in lighting or color, changes in viewing direction, changes in size/shape, detect edges in template and image, compare edges images to find the template. The image processing algorithm also may consider a range of possible template positions, 3D modeling.

Traditionally there are three popular ways to represent a model. In polygonal modeling, points in 3D space, called vertices, are connected by line segments to form a polygon mesh. The vast majority of 3D models today are built as textured polygonal models, because they are flexible and because computers can render them quickly. However, polygons are planar and can only approximate curved surfaces using many polygons. In curve modeling, surfaces are defined by curves, which are influenced by weighted control points. The curve follows but does not necessarily interpolate the points. Increasing the weight for a point will pull the curve closer to that point. Curve types include non-uniform rational B-spline NURBS, splines, patches, and geometric primitives.

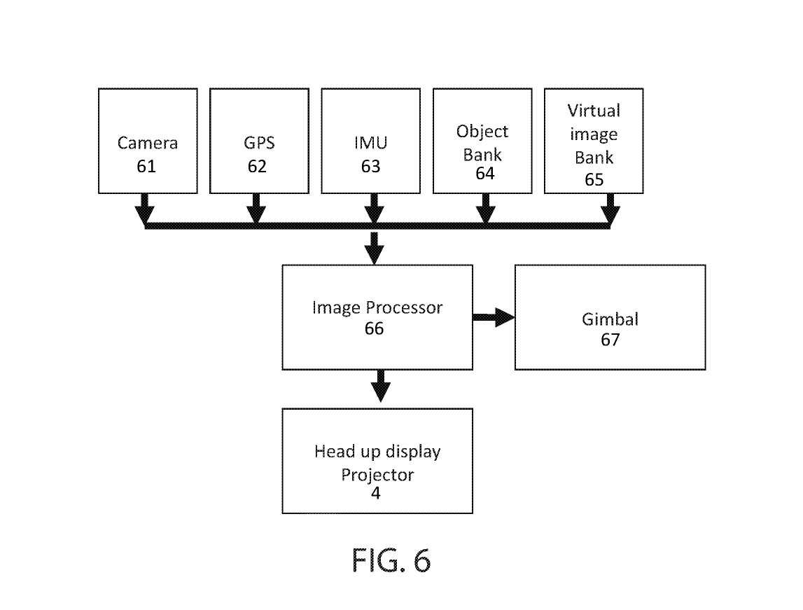

Referring to FIG. 6 the image processor, which may be implemented as a programmable computer such as a tablet, receives information from five major input systems. Camera 61, GPS 62, IMU—Inertial Measurement Unit 63, object bank 64 and virtual image bank 65. The image processor then calculates the virtual image 3 and transmits data to the gimbal for further correction. Another possible implementation entails preparing, in advance, a pre-made video file such as an MP4. In this video, the object moves inside the frame in a predetermined velocity. The video file display speed can be played corresponded to the vehicle speed, to achieve an effect of stationary object on moving landscape.

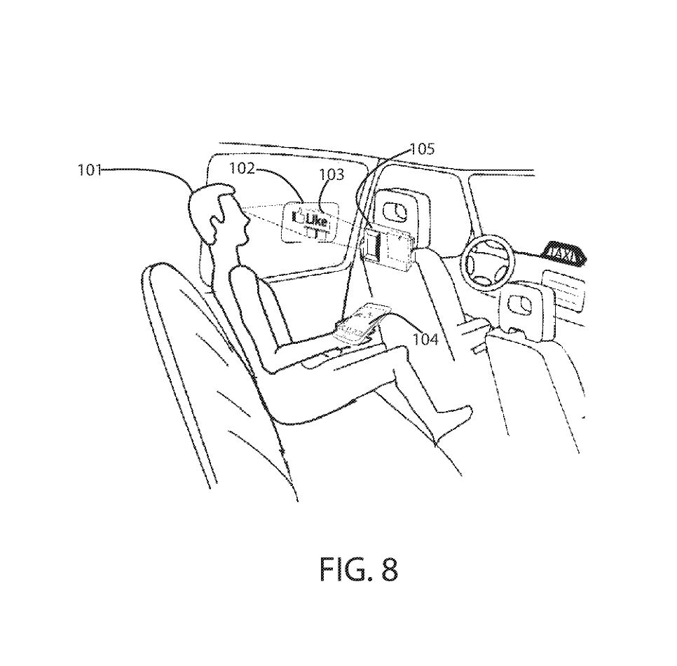

In one embodiment, with reference to FIG. 8, a smart phone 104 displays the same advertisement 103 that is projected on the window by the projector 105. The advertisement displayed on the smart phone 104 may include a link or other GUI control. User 101 selection or activation of the link or control may trigger additional actions, such as display of additional information, navigation to a website, or user entry of a choice. The smart phone 104 equipped with a location system, such as a GPS, determines the location of the user. The computing equipment within the vehicle, e.g., a tablet, also contains a location system, such as a GPS. The location of the smart phone and vehicle remain the same for the duration of the trip. The locations may be shared between the devices via wireless communication either peer to peer or via the Internet. Upon determining that the smart phone 104 is within a vehicle equipped with a computing device according to principles of the invention, advertisements displayed on the window of the vehicle may be sent to the smart phone for display. By way of example and not limitation, a smart phone 104 within a vehicle may execute a social networking application, such as Facebook. Advertisements displayed on the window of the vehicle may be sent to the social networking application. A user of the smart phone may then interact with the advertisement on the smart phone, such as by indicating that the user “likes” 102 the advertisement, sharing the advertisement with others, or selecting the advertisement as a link to obtain more information. Input from a smart phone may affect the advertisement or other subject matter projected on the window. Such user input may be communicated from the smart phone to the computing system within the vehicle.

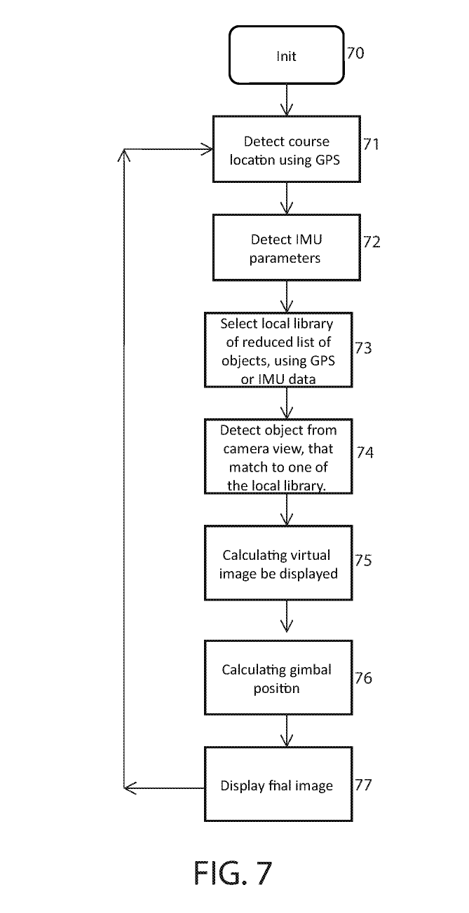

The process of FIG. 7 entails determining projection parameters based upon location, direction and speed. Projection parameters include gimbal and image settings and output. In step 70 the process is initiated, such by executing one or more programs on a computing device, such as a tablet equipped with a GPS chip set (GPS unit) and an inertial measurement unit (IMU). Location and course are detected with the GPS unit in step 71. IMU parameters (e.g., acceleration and angular rate) are detected in step 72. Objects to display in the vicinity of the vehicle, given the direction of travel and orientation of the vehicle, are selected in step 73. An object that corresponds to a real world object identified through a camera (e.g., CCD) is identified in step 74. The virtual image to be projected on the window for display is determined in step 75. The position and movement of the projected image is determined, along with the requisite gimbal parameters in step 76. Then the image is displayed in step 77. The process repeats as the vehicle travels. In this manner, relevant projected images overlay or complement real world objects. The projected images may by promotional, advertising, informational or entertaining.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. An augmented reality projection system comprising a reflective coating on a passenger window of a moving vehicle, a projector aimed at the reflective coating, an image processor operably coupled to the projector, a virtual image bank accessible from the image processor, the image processor selecting an image from the image bank and causing the projector to project the image on the reflective coating on the window.

2. An augmented reality projection system according to claim 1, further comprising a global positioning system operably coupled to the image processor, the image processor determining a location using the global positioning system, and the image selected from the image bank being an image associated with the determined location.

3. An augmented reality projection system according to claim 2, further comprising an inertial measurement unit operably coupled to the image processor, the image processor determining a motion using the inertial measurement unit, and the image selected from the image bank being an image associated with the determined location and the determined motion.

4. An augmented reality projection system according to claim 1, further comprising a camera aimed at the passenger window, the image processor using the camera to determine location of the image projected on the window.

5. An augmented reality projection system according to claim 1, further comprising a positioning system including a gimbal assembly providing two axes of freedom, a pair of motors operably coupled to the gimbal system to cause rotations about the two axes of freedom, a mounting base and a platform, the gimbal assembly being pivotally coupled between the mounting base and platform, the projector being mounted to the platform, a motor controller for controlling each motor, the motor controller operably coupled to the image processor, and the image processor causing the positioning system to aim the projector at a first determined portion of the reflective coating on the passenger window at a first time.

6. An augmented reality projection system according to claim 1, and the image processor causing the positioning system to aim the projector at a second determined portion of the reflective coating on the passenger window at a second time.

7. An augmented reality projection system according to claim 1, further comprising a positioning system including a gimbal assembly providing two axes of freedom, a pair of motors operably coupled to the gimbal system to cause rotations about the two axes of freedom, a mounting base and a platform, the gimbal assembly being pivotally coupled between the mounting base and platform, the projector being mounted to the platform, a motor controller for controlling each motor, the motor controller operably coupled to the image processor, and the image processor causing the positioning system to aim the projector at a continuum of portions of the reflective coating on the passenger window over a first period of time.

8. An augmented reality projection system according to claim 1, further comprising a portable computing device, the image processor communicating first information related to the image projected on the reflective coating on the window to the portable computing device, and the portable computing device communicating second information.

9. An augmented reality projection system according to claim 8, the second information being communicated to a remote computing system.

10. An augmented reality projection system according to claim 8, the second information being communicated to the image processor.

11. An augmented reality projection system according to claim 8, the second information indicating a user input.

12. An augmented reality projection system according to claim 8, the portable computing device being a smart phone.

13. An augmented reality projection system according to claim 9, the remote computing system hosting a social network.

14. An augmented reality projection system according to claim 11, the user input corresponding to a subjective assessment relating to the projected image.

15. An augmented reality projection system according to claim 13, the second information indicating a user input, the user input corresponding to a subjective assessment relating to the projected image, and the social network publishing the second information.
